(19) United States
(12) Patent Application Publication
(10) Pub. No.: US 2002/0120522 A1
(43) Pub. Date: Aug. 29, 2002

(54) On-line purchasing process using a computer and a system for the same

(76) Inventor: Chen-Shi Yang, Shi-Chih City (TW)

Correspondence Address: DOUGHERTY & TROXELL, 5205 Leesburg Pike, Sutie 1404, Falls Church, VA, 22041, US

(21) Appl. No.: 09/791,712

(22) Filed: Feb. 26, 2001

(51) Int. Cl. G06F 17/60

(52) U.S. Cl. 705/26; 705/37

(57) ABSTRACT

An on-line purchasing process using a computer and a system for the same are provided, in which a business web site is set up in a server of a company (buyer), such that the buyer can go on line to purchase what they want from the suppliers. The web site mainly has a supplier trading system that allows a plurality of suppliers going on line to register their basic information and the products they sell. The supplier trading system of the present invention includes a quotation management system, a product trading management system, an inquiry/negotiation management system and an order searching management system. It is the main object of the present invention to provide a simplified purchase procedure and open inquiry/negotiation process to reduce the management cost for the purchase and the labor.

### BACKGROUND OF INVENTION

1. Field of Invention

The present invention relates to an on-line purchasing process using a computer and the system for the same. More particularly, the present invention relates to an on-line purchasing process and a system for the same, in which all of the products available from the suppliers are integrated and the buyer can trade with the suppliers on line. With a platform of the present invention, not only the buyer can trade with the suppliers on the web, but also integrate the management after trading.

2. Description of the prior art

Conventionally, the enterprise purchase model is that in which the purchase is performed by purchase employees. Only after the enterprise employees pointed out the demands, then the purchase employees can inquiry, compare, and negotiate the prices of products to be purchased vis-à-vis the suppliers. More particularly, the order of the products is performed only after the inquiry and negotiation of purchase prices were achieved. Such a purchase process is time consuming, and has other drawbacks such as complete confidence in the purchase employees of the enterprise, the type of the suppliers, the amount and documents not easy to obtain, and non-opened negotiation process. In this state of affair, if an experienced purchase employee happens to quit the company, a newly employed purchase employee cannot learn immediately the know-how acquired by the former purchase employee, and needs to learn from scratch. Although many enterprises currently employ sale-stock software applications, most of them rely those software applications to provide only data records and paperwork management, while crucially missing the functionality of information analysis and decision propositions. As a result, conventional human resource for purchase, sales, management, and accounting cannot be entirely replaced. Moreover, the integration of the information related to all of the suppliers cannot be performed. This lack of information integration causes the enterprise not to be able to make the correct decisions at crucial moment.

### SUMMARY OF THE INVENTION

A major aspect of the present invention is to provide a on-line purchase process using a computer and a system for the same, in which there are provided a simplified purchase process and opened inquiry/quotation information to reduce the human resource management cost.

Another aspect of the present invention is to provide an on-line purchase process using a computer and a system for the same, in which the information related to the buyer and the suppliers can be integrated through a web site to achieve electronic management of replenishment/sale/stock

Yet another aspect of the present invention is to provide an on-line purchase process using a computer and a system for the same, in which an analysis of the information about the suppliers can be quickly carried out to provide a strategy proposition.

### BRIEF DESCRIPTION OF THE DRAWINGS

The objects, features and advantages of the present invention will be better understood through the following detailed description with the help of the accompanying drawings, wherein:

FIG. 1 is a schematic diagram showing a configuration of on-line trading according to the present invention;

FIG. 2 is a block diagram showing an on-line trading method by using a computer and a system for the same according to the present invention;

FIG. 3 is a flowchart showing product quotation trading according to the present invention;

FIG. 4A is a flowchart showing the management of the product purchasing demand;

FIG. 4B is a flowchart showing the product advanced searching according to the present invention;

FIG. 5A is a flowchart showing the inquiry/negotiation according to the present invention;

FIG. 5B is a flowchart showing the inquiry/negotiation sheet recording management according to the present invention;

FIG. 6A is a flowchart showing the order management system according to the present invention; and

FIG. 6B is a flowchart showing the account receivable management system according to the present invention.

### Detailed Description of the Invention

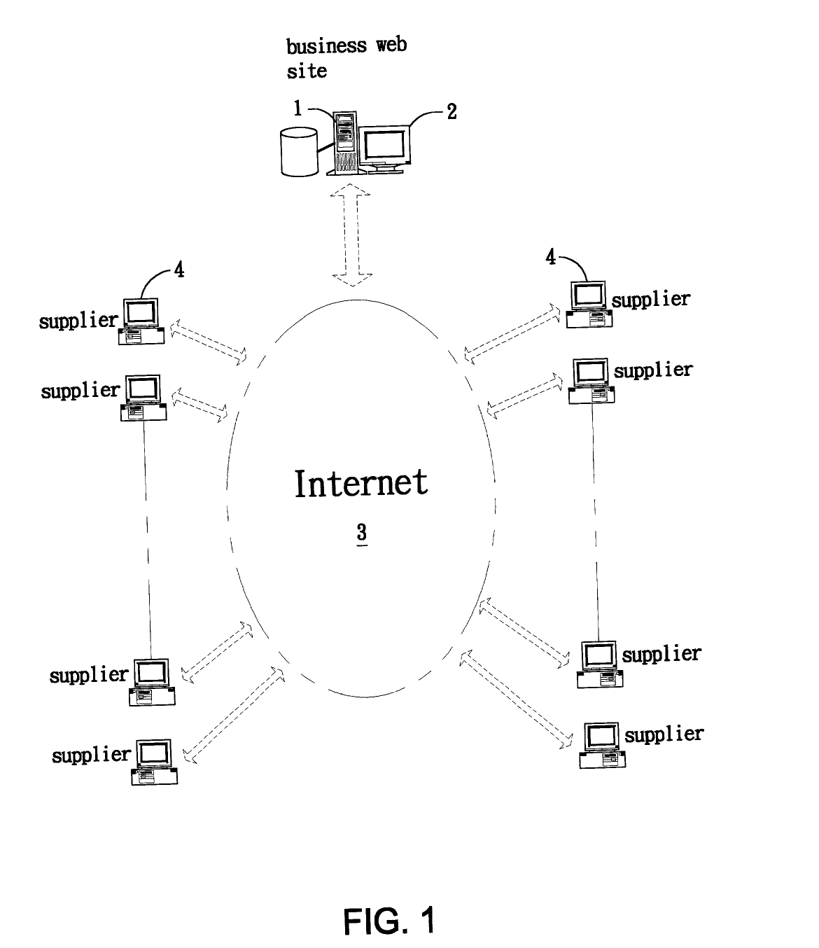

FIG. 1 is a schematic diagram showing a configuration of on-line trading according to the present invention. In the on-line purchasing process using a computer and a system for the same according to the present invention, a business web site 2 is set up in a server 1 of a company (buyer), such that the buyer can go on line through Internet 3 to purchase what they want from the suppliers 4. Each of the suppliers 4 can also connect to Internet 3 and register into the web site 2 to trade with the buyer. The web page format of the web site 2 can be written in a conventional language such as HTML, JAVA SCRIPT, SQL, and JSP, and includes the use of conventional cast structure, object oriented technology and interactive interface. The hardware that is employed to connect to Internet comprises computers, modems, xDSL modems, cable modems, ADSL, etc, while the software that are used comprises a web page browser and an e-mail sender/receiver.

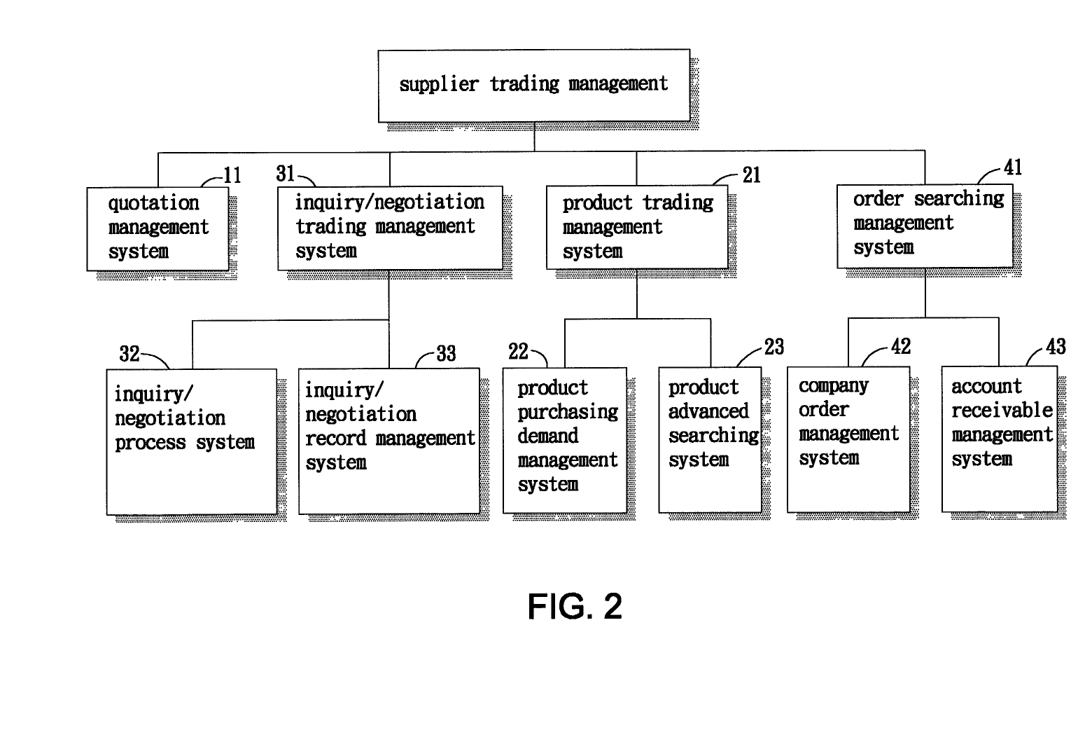

FIG. 2 is a block diagram showing an on-line trading method by using a computer and a system for the same according to the present invention. In a preferred embodiment of the present invention, a business web site 2 is built up in a server 1 of a company. The business web site 2 includes introduction about the company, production information and a supplier trading management system 10. The system 10 allows a plurality of suppliers 4 to register on line their basic information and the products they sell. Once a supplier registers on line, the information is automatically saved in the server 1, such that executive operation can be done without input of its basic information again when the registered supplier visits the site next time.

The supplier trading management system 10 of the present invention includes a quotation management system 11, a production trading management system 21, an inquiry/negotiation management system 31, and an order searching management system 41. The quotation management system 11 is a management system that provides quotation of the products sold by the supplier to the buyer. In the present invention, the quotation can be provided to the company (referred as a buyer) after the products available from different suppliers are arranged. The quotation management system 11 advantageously provides following functions:

1. All the products to be sold are listed on the quotation by each supplier for the buyer to choose among those products.

2. The suppliers provide the buyer with a quotation after they arrange the products to be sold to the buyer.

3. Certain products the buyer purchased or the buyer wants to purchase are listed on the quotation.

The quotation made by each of the suppliers is transmitted to the buyer for negotiation. Therefore, with the management system of the present invention, it is not necessary for a buyer to perform negotiation with each supplier, resulting in reduced purchasing time and labor cost.

In the supplier trading management system 10, the product trading management system 21 manages the products that are available from the supplier and the products the buyer wants to purchase. The product trading management system 21 further includes a product purchasing demand system 22 and a product advanced searching system 23. The product trading management system 21 provides the following functions:

1. After selecting and arranging the products, the supplier can provide the buyer with their arranged products.

2. The supplier can watch which products the buyer would purchase in a certain period or which products the supplier can purchase for the buyer.

3. Either the product trading management system 21 can automatically take down what the buyers purchased or the buyers can input what they need into the product trading management system 21 such that the supplier can provide the quotation, depending on the demand of the buyer.

In the supplier trading management system 10 of the present invention, the inquiry/negotiation management system 31 manages the quotation from the supplier and negotiation with the supplier. The quotation/negotiation trading management system 31 further includes an inquiry/negotiation process system 32 and an inquiry/negotiation recording management system 33. The inquiry/negotiation trading management system 31 allows the buyer negotiating with the supplier in regard with the quotation, and allows the supplier recording either the inquiry/negotiation in question or special trades as well for other trade or for further re-negotiation.

In the supplier trading system 10 of the present invention, the order searching management system 41 is used for the order from the buyer. The order searching management system 41 further includes a company order management system 42 and an account receivable management system 43. The order searching management system 41 manages the order post process, such as delivering of the products and reminder of the account.

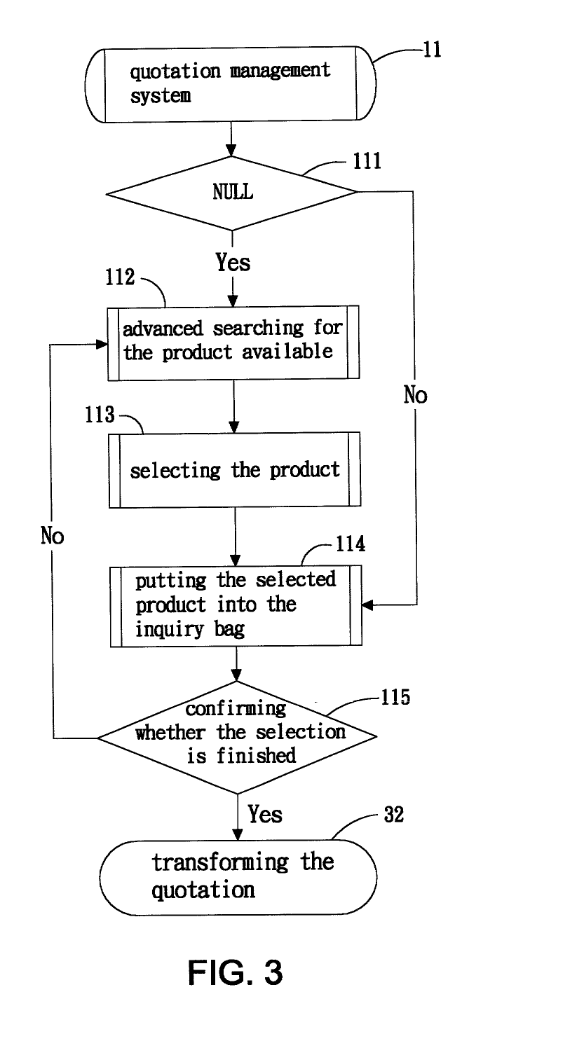

FIG. 3 is a flowchart showing product quotation trading according to the present invention. The quotation management system 11 of the present invention is used for the suppliers to provide quotations of their products. The quotation trading includes the steps of:

(a) checking whether the quotation is fulfilled or empty. If the quotation is not empty, then go to step (d). Otherwise, go to the next step;

(b) entering the company product advanced searching (step 112). When the supplier inputs the product name or product code or clicks a product icon, the system 11 lists all of the information related to the product such as product name, product specification, amount, prices etc. Since the product information available from the supplier was saved in the server 1 after the supplier has registered the supplier trading management system 10 the first time, no input is needed and the product information is found by searching;

(c) selecting the product item to be listed on the quotation this time (step 113).

(d) putting the selected product item into the inquiry bag (step 114);

(e) confirming whether the selection is finished or not. If not finished, repeat step (b) to step (e). If finished, go to the next step; and

(f) transforming the product item of the inquiry bag into the quotation, and saving it in the server 1 to run the quotation/negotiation process system 32.

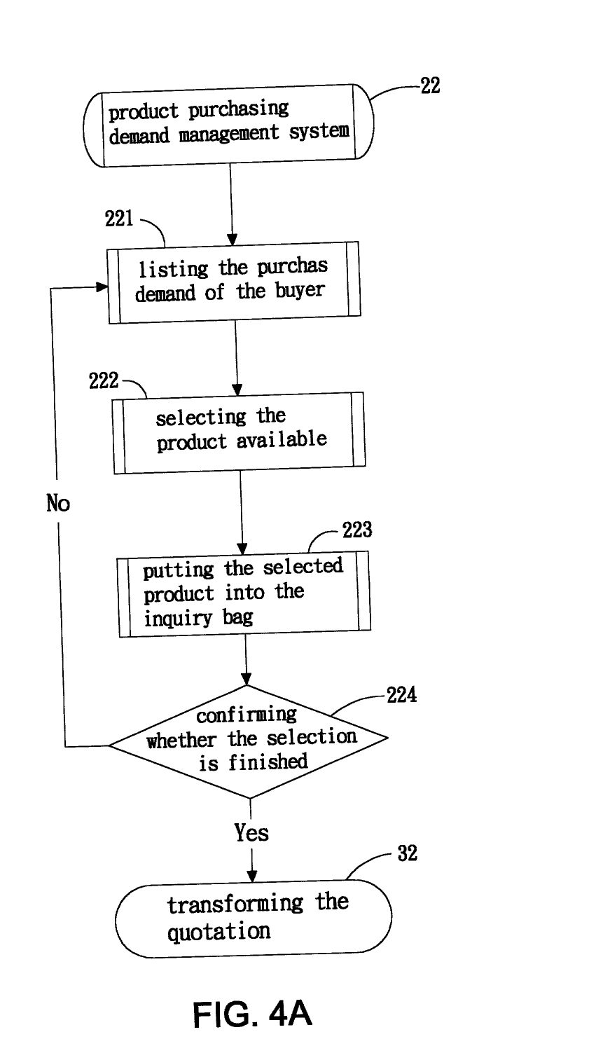

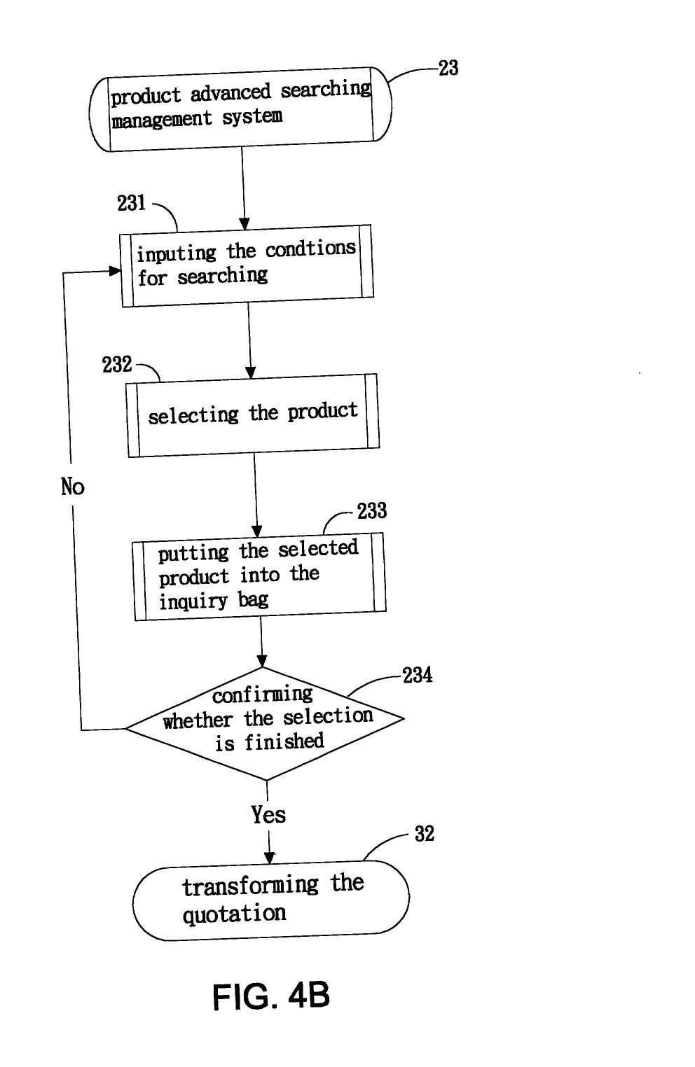

FIG. 4A is a flowchart showing the management of the product purchasing demand. The product purchasing demand management system 22 is used for the suppliers to watch either the products purchased by the buyer at certain period or the products they can purchase for the buyer. The products the buyer purchased would be automatically recorded in the present invention. Alternatively, the buyer can input the desired products in the product trading management system 21 for the supplier to provide a quotation according to the buyer's demand. The product purchasing demand management system 22 is executed in the following steps:

(a) listing all the records saved in the server 1, showing what products are purchased or what the buyer wants to purchase (step 221);

(b) selecting the product item available and providing the quotation thereof by the supplier (step 222);

(c) putting the product item selected into the quotation bag (step 223).

(d) confirming whether the selection is finished or not. If not finished, then repeat steps (a) to (d). If finished, then go to the next step (step 224); and

(e) transforming the product item of the inquiry bag into the quotation and saving it in the server 1 to run the inquiry/negotiation process system 32.

FIG. 4B is a flowchart showing the product advanced searching according to the present invention. The supplier can provide the quotation after the products were arranged according to the buyer's demand. The product advanced searching for product arrangement carried out by the supplier includes:

(a) inputting conditions for searching (step 231). After either inputting a product name or a product code to be arranged, or clicking a product icon to be arranged, all the information about the product is listed;

(b) selecting the product item to be arranged (step 232);

(c) putting the selected product item into the inquiry bag (step 233);

(d) confirming whether the selection is finished or not. If not correct, repeat steps (a) to (d). If correct, then go to the next step (step 234); and

(e) transforming the product item in the inquiry bag into the quotation and saving it in the server 1 to run inquiry/negotiation process system 32.

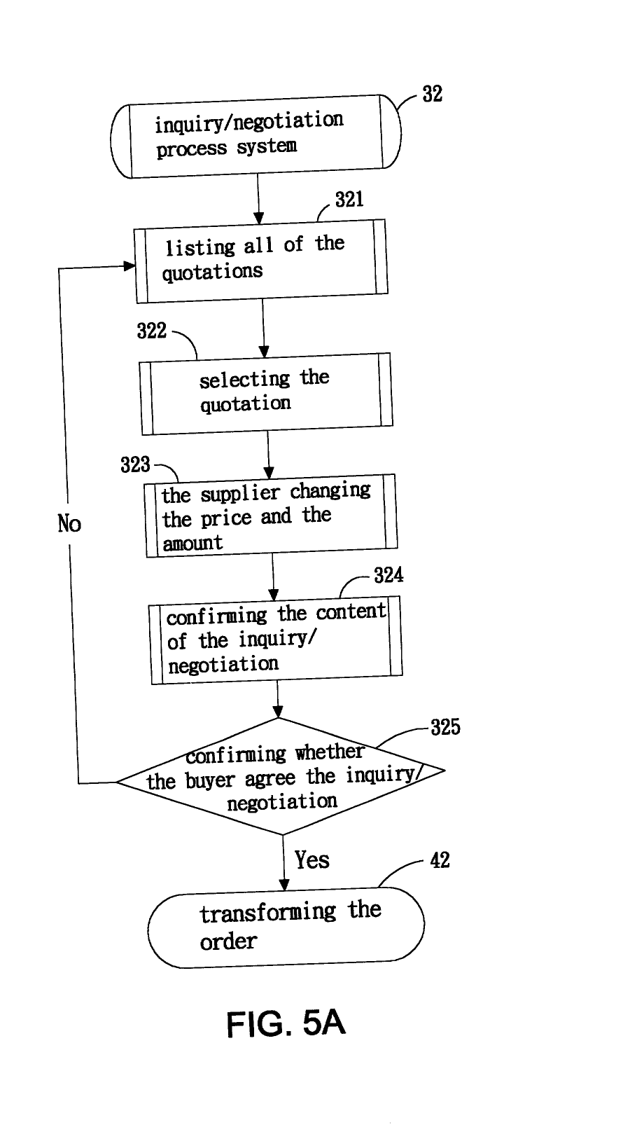

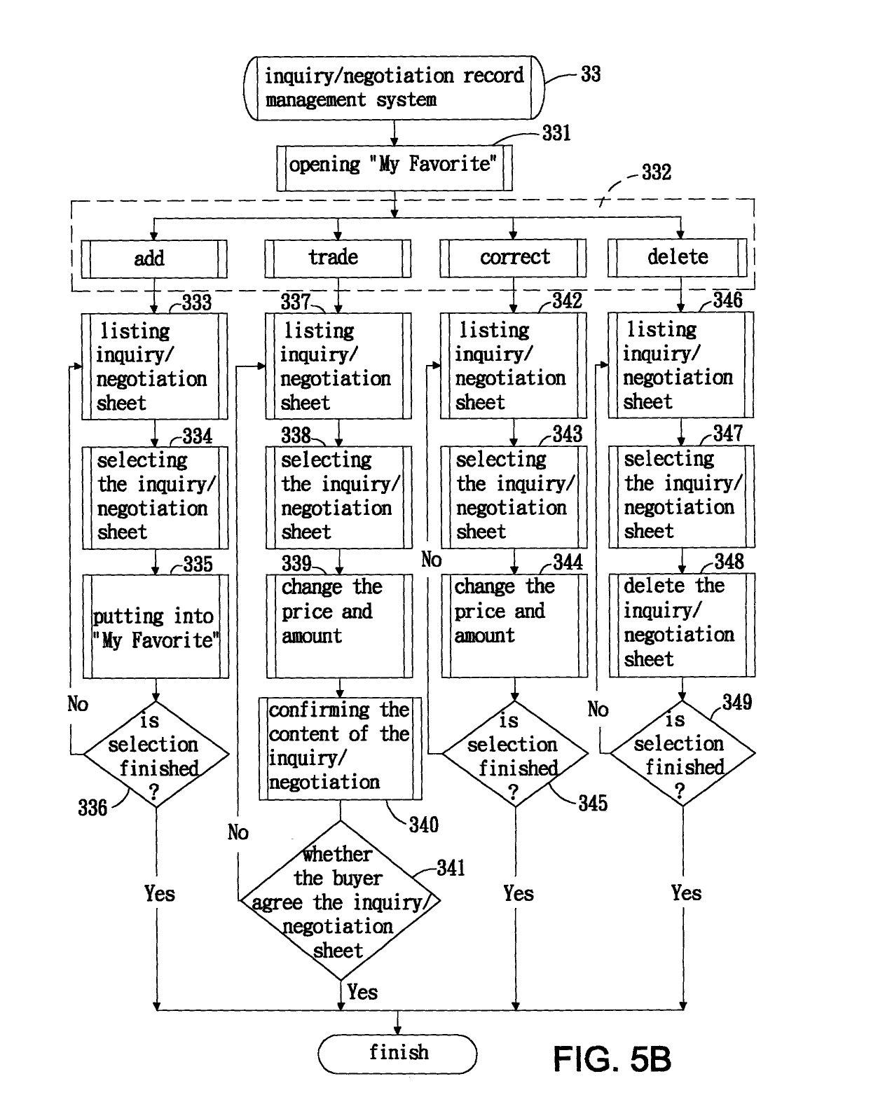

FIG. 5A is a flowchart showing the inquiry/negotiation according to the present invention. The inquiry/negotiation process system 32 of the present invention allows the buyer negotiating the quotation with the supplier. The inquiry/negotiation process system 32 is execute in the following steps:

(a) listing all of the quotations saved in the server 1 (step 321);

(b) The supplier selecting the quotation to be inquired or negotiated (step 322);

(c) The supplier changing the amount and the price of the product item listed on the quotation (step 323);

(d)confirming whether the content of the quotation is correct. If not correct, then correct the quotation. If correct, then transform the quotation into the inquiry/ negotiation sheet and save it in the server 1 (step 324).

(e) confirming whether the buyer agrees with the inquiry/negotiation sheet. If no, then repeat step (a) to step (e). If yes, then go to the next step 325.

(f) Transforming the inquiry/negotiation sheet into order and saving it in the server 1 to run the company order management system 42.

FIG. 5B is a flowchart showing the inquiry/negotiation sheet recording management according to the present invention. Since numerous suppliers and trade records are saved in the server, many inquiry/negotiation sheet records may be obtained when searching, thus resulting in wasting time on searching the inquiry wanted. Therefore, with the system of the present invention, either the inquiry/negotiation sheets on inquiry/negotiation are saved, or the inquiry/negotiation for special trades, such as urgent cases, is saved for next-time trade or re-negotiation. Each supplier is allowed to use their “My Favorite” to manage the records of the inquiry/negotiation sheet. The inquiry/negotiation sheet recording management provides the following functions:

1. The inquiry/negotiation sheet can be added to “My Favorite”;

2. The inquiry/negotiation sheet in “My Favorite” can be clicked to perform inquiry/negotiation.

3. The inquiry/negotiation sheet in “My Favorite” can be corrected.

4. The inquiry/negotiation sheet in “My Favorite” can be deleted.

The inquiry/negotiation sheet record management system 33 is executed in the following steps:

(a) opening “My Favorite” (step 331);

(b) selecting the operation to be carrier out (step 332): If select “add”, then go to step (c). If select “trade”, then go to step (g). If select “correct”, then go to step (m). If select “delete”, then go to step (q);

(c) listing the inquiry/negotiation sheet saved in the server 1 (step 333).

(d) selecting the inquiry/negotiation sheet to be saved (step334);

(e) putting the inquiry/negotiation sheet to be saved into “My Favorite” (step 335);

(f) confirming whether the selection is finished (step 336) or not. If not finished, then go to step (c) to (f). If finished, then save “My Favorite” in the server 1 to finish the operation of “add”; (g) listing the inquiry/negotiation sheet saved in the server 1 (step 337).

(h) selecting the inquiry/negotiation sheet to be saved (step338);

(i) changing the price and the amount of the product item listed in the inquiry/negotiation sheet (step 339);

(j) confirming the content of the changed inquiry/negotiation sheet is correct. If not correct, then correct it. If correct, then save the inquiry/negotiation sheet in the server 1 (step340);

(k) confirming the buyer agrees with this inquiry/negotiation sheet. If no, then repeat steps (G) to (k). If yes, then go to the next step 341;

(l) Transforming the inquiry/negotiation sheet into order and saving it in the server 1 to run the company order management system 42;

(m) listing all the inquiry/negotiation sheets saved in “My Favorite” (step 342);

(n) selecting the inquiry/negotiation sheet needed to be changed (step 343);

(o) changing the price and amount of the product item in the inquiry/negotiation (step 344);

(p) confirming the selection is finished (step 345). If not finished, then go to step (m) to (p). If finished, then save “My Favorite” in the server 1 to finish the operation of“change”;

(q) listing the inquiry/negotiation sheet saved in “My Favorite” (step 346);

(r) selecting the inquiry/negotiation sheet to be deleted (step347);

(s) deleting the selected inquiry/negotiation sheet (step 348);

(t) confirming the selection is finished (step 349). If not finished, then go to step (q) to (t). If finished, then save “My Favorite” in the server 1 to finish the operation of delete”.

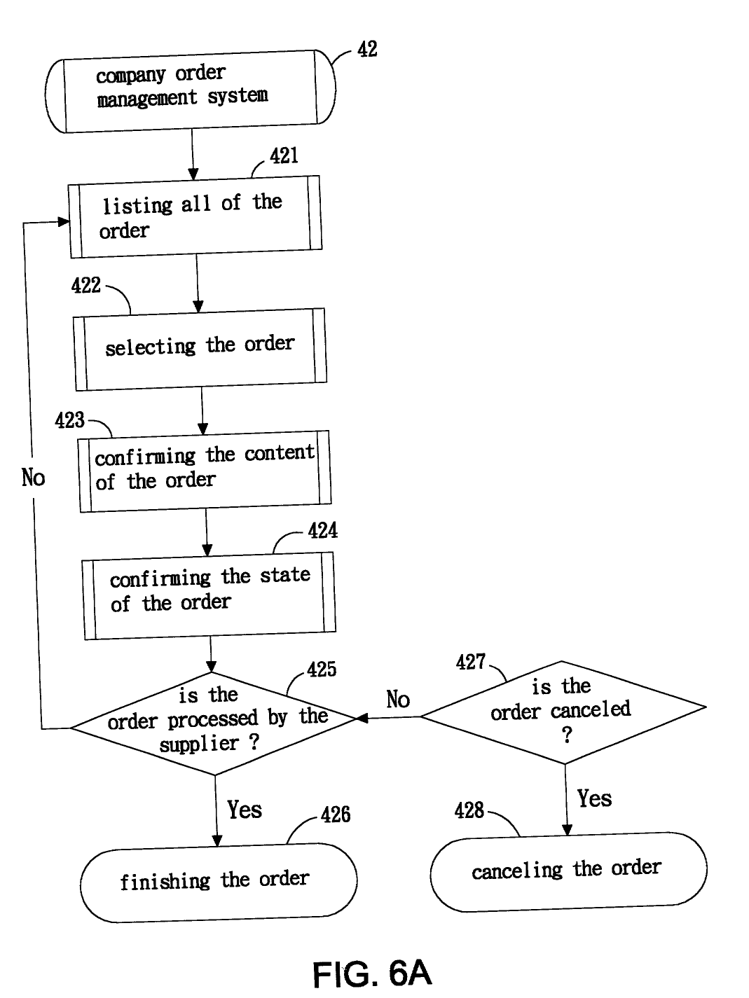

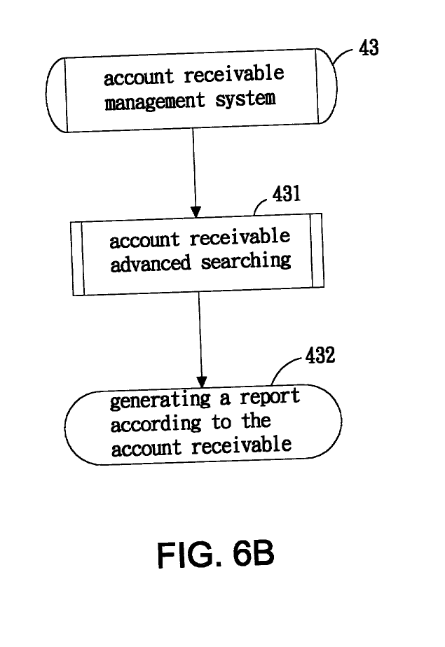

FIG. 6A is a flowchart showing the order management system according to the present invention. The order management system 42 of the present invention is executed in the following steps:

(a) listing all of the order sheets saved in the server 1 (step 421);

(b) selecting the order to be processed (step 422);

(c) confirming the content of the order is correct. If not, then inform the buyer the incorrect order (step 423);

(d)confirming the state of the purchase order, including whether the order is processed by the supplier, whether the product is delivered, or whether the account is received (step 424);

(e) if the supplier has not processed the order yet, then repeat steps (a) to (c) (step 425);

(f) when step (e) is finished, the purchase process is finished (step 426);

(g) at step (d) of confirming state, cancellation of the order is detected automatically. If not canceled the go to step (e). If canceled, then go to the next step;

(h) canceling the order.

FIG. 6B is a flowchart showing the account receivable management system according to the present invention. With the system of the present invention, an account receivable daily report, a weekly report, a monthly report, a seasonally report or annually report is generated as desired. The supplier can run the account receivable management system 43 to generate the account receivable report as recited above. The account receivable management system 43 is executed in the following steps of (a) entering account receivable advanced searching to search for daily sale records, weekly sale records, monthly sale records, seasonally sale records, or annually sale records as desired (step 431), and (b) generating the report according to the recorded account receivable (step 432).

The on-line trading method by using a computer according to the present invention provides:

1. simplified purchase procedure, reduced cost, reduce labor and increased efficiency of management;

2. selection for differently functional elements as desire to manage replenishment/sales/stock electronically.

3. a platform of electronic trade market as an inquiry/negotiation tool in a collective trade.

As understood by a person skilled in the art, the foregoing description of the preferred embodiment and examples of the present invention are only illustrative rather than limiting. Revisions and modifications may be made to processes, materials, and structures through which is provided the foregoing embodiment of the present invention without departing from the spirit and scope of the present invention as defined by the following appended claims.

What is claimed is:

1. An on-line purchasing system using a computer, wherein a business web site is set up in a server of a buyer such that the buyer can go on line to purchase what they want from any one of suppliers, and wherein the web site mainly has a supplier trading system that allows a plurality of suppliers going on line to register their basic information and the products they sell, the supplier trading system comprising:
a quotation management system which is a management system for the suppliers to provide the buyer quotations;
a product trading management system which is used to manage the products available from the suppliers and the products the buyer wants to purchase;
an inquiry/negotiation management system which manages inquiry/negotiation between the buyer and the suppliers; and
an order searching management system which is used for the suppliers to manage the order made by the buyer.

2. An on-line purchasing process using the on-line purchasing system of claim 1, wherein the quotation management system is executed in steps of:
(a) checking whether the quotation is fulfilled or empty. If the quotation is not empty, then go to step (d). Otherwise, go to the next step;
(b) entering the company product advanced searching. When the supplier inputs a product name or a product code or clicks a product icon, the information related to the products would be listed;
(c) selecting the product item to be listed on the quotation this time
(d) putting the selected product item into the inquiry bag;
(e) confirming whether the selection is finished or not. If not finished, then repeat step (b) to step (e). If finished, then go to the next step;
(f) transforming the product item of the inquiry bag into the quotation; and saving it in the server 1 to run the quotation/negotiation process system.

3. The on-line purchasing system of claim 1, wherein the product trading management system further comprises:
a product purchasing demand system, and
a product advanced searching system, wherein the product trading management system allows the supplier providing the buyer with their arranged products after the products are selected and arranged; or wherein the product trading management system allows the supplier watching which products the buyer would purchase in a certain period or which products the supplier can purchase for the buyer; or wherein the product trading management system automatically takes down what the buyers purchased, or the buyers can input what they need into the product trading management system such that the supplier can provide the quotation according to the demand of the buyer.

4. The on-line purchasing system of claim 1, wherein the inquiry/negotiation management system further comprising:
an inquiry/negotiation process system and
an inquiry/negotiation recording management system,
wherein the inquiry/negotiation trading management system allows the buyer negotiating with the supplier in regard with the quotation and also allows the supplier recording the inquiry/negotiation in question or some special trade as well for other trade or for further re-negotiation.

5. The on-line purchasing system of claim 1, wherein the order searching management system further comprising:
a company order management system, and
a account receivable management system,
wherein the order searching management system manages the post process of the order, such as delivering of the products and reminder of the account.

6. An on-line purchasing process using the on-line purchasing system of claim 3, wherein the product purchasing demand management system is executed in the steps of:
(a) listing all the records saved in the server, showing what products are purchased or what the buyer wants to purchase;
(b) selecting the product item available and providing the quotation thereof by the supplier;
(c) putting the product item selected into the quotation bag;
(d) confirming whether the selection is finished or not. If not finished, then repeat steps (a) to (d). If finished, then go to the next step;
(e) transforming the product item of the inquiry bag into the quotation and saving it in the server to run the inquiry/negotiation process system.

7. An on-line purchasing process using the on-line purchasing system of claim 3, wherein the product advanced searching is executed in steps of:
(a) inputting conditions for searching. After whether inputting a product name or a product code to be arranged, or clicking a product icon to be arranged, all the information about the product is listed;
(b) selecting the product item to be arranged;
(c) putting the selected product item into the inquiry bag;
(d) confirming whether the selection is finished or not. If not finished, then repeat steps (a) to (d). If finished, then go to the next step; and
(e) transforming the product item in the inquiry bag into the quotation and saving it in the server to run inquiry/negotiation process system.

8. An inquiry/negotiation process using the on-line purchasing system of claim 4, wherein the inquiry/negotiation process system is execute in steps
(a) listing all of the quotations saved in the server;
(b) the supplier selecting the quotation to be inquired or negotiated;
(c) the supplier changing the amount and the price of the product item listed on the quotation;
(d) confirming whether the content of the quotation is correct. If not correct, then correct the quotation. If correct, then transform the quotation into the inquiry/ negotiation sheet and save it in the server;
(e) confirming whether the buyer agrees with the inquiry/negotiation sheet. If no, then repeat step (a) to step (e). If yes, then go to the next step;
(f) transforming the inquiry/negotiation sheet into order and saving it in the server to run the company order management system.

9. The inquiry/negotiation sheet recording management process of claim 8, wherein the inquiry/negotiation sheet recording management system allows each supplier using their “My Favorite” to manage the records of the inquiry/negotiation sheet, the inquiry/negotiation sheet recording management comprising:
(a) adding the inquiry/negotiation to “My Favorite”;
(b) clicking the inquiry/negotiation sheet in “My Favorite” to perform inquiry/negotiation;
(c) correcting the inquiry/negotiation sheet in “My Favorite”
(d) deleting the inquiry/negotiation sheet in “My Favorite”.

10. The inquiry/negotiation sheet recording management process of claim 9, wherein adding the inquiry/negotiation to “My Favorite” comprising:
(a) opening “My Favorite”;
(b) listing the inquiry/negotiation sheet saved in the server;
(c) selecting the inquiry/negotiation sheet to be saved;
(d) putting the inquiry/negotiation sheet to be saved into “My Favorite”;
(e) confirming the selection is finished. If not finished, then go to step (a) to (e). If finished, then save “My Favorite” in the server.

11. The inquiry/negotiation sheet recording management process of claim 9, wherein clicking the inquiry/negotiation sheet in “My Favorite” comprising:
(a) opening “My Favorite”;
(b) listing the inquiry/negotiation sheet saved in the server 1;
(c) selecting the inquiry/quotation to be traded;
(d) changing the price and the amount of the product item listed in the inquiry/negotiation sheet;
(e) confirming the content of inquiry/negotiation sheet is correct. If not correct, then correct it;
(f) confirming the enterprise agrees the inquiry/negotiation sheet. If no, then repeat step (b) to (f). If yes, then go to next step;
(g)transforming the inquiry/negotiation sheet into a purchase order to run the enterprise purchase order management system.

12. The inquiry/negotiation sheet recording management process of claim 9, wherein changing the inquiry/negotiation sheet in “My Favorite” comprising:
(a) opening “My Favorite”;
(b) listing the inquiry/negotiation sheet saved in the server 1;
(c) selecting the inquiry/quotation to be changed;
(d) changing the price and the amount of the product item listed in the inquiry/negotiation sheet;
(e) confirming the selection is finished or not. If not finished, then repeat steps (b) to (e). If finished, then save “My Favorite” in the server;
(f) finishing “change”.

13. The inquiry/negotiation sheet recording management process of claim 9, wherein the deleting the inquiry/negotiation sheet in “My Favorite comprising:
(a) opening “My Favorite”;
(b) listing the inquiry/negotiation sheet saved in the server;
(c) selecting the inquiry/negotiation sheet to be deleted;
(d) deleting the inquiry/negotiation sheet;
(e) confirming the selection is finished. If not finished, then go to step (b) to (e). If finished, then save “My Favorite” in the server.
(f) finishing “delete”.

14. An order searching management process using the order searching management system of claim 5, comprising:
(a) listing all of the order sheets saved in the server;
(b) selecting the order to be processed;
(c) confirming the content of the order is correct. If not correct, then inform the buyer of the incorrect order;
(d) confirming the state of the purchase order, including whether the order is processed by the supplier, whether the product is delivered, or whether the account is received;
(e) if the supplier has not processed the order yet, then repeat steps (a) to (c);
(f) when step (e) is finished, the purchase process is finished.

15. The order searching management process of claim 14, wherein in step (d) of confirming state, cancel of the order is detected automatically; if the order doesn't be canceled, then go to step (e); otherwise the purchase trade is canceled.

16. An order searching management process using a order searching management system of claim 5, wherein the account receivable management system is executed in steps of:
(a) entering account receivable advanced searching system to search for daily sale records, weekly sale records, monthly sale records, seasonally sale records, or annually sale records as desired, and
(b) generating the report according to the recorded account receivable.
